(19) United States
(12) Patent Application Publication
(10) Pub. No.: US 2005/0002491 A1
(43) Pub. Date: Jan. 6, 2005

(54) Vacuum housing with a protective layer for an-x-ray tube

(76) Inventor: Eberhard Lenz, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/841,338

(22) Filed: May 7, 2004

(30) Foreign Application Priority Data
May 8, 2003 (DE) 103 20 700.7

(51) Int. Cl. H05H 1/00; G21G 4/00; H01J 35/00; H01J 35/10; H01J 35/12

(52) U.S. Cl. 378/119

(57) ABSTRACT

A vacuum housing for an x-ray tube has a wall provided with a protective layer at least in an area near a focal spot of the x-ray tube that arises in the operation of the x-ray tube. In order to increase the lifespan, the protective layer of a material which can be one or more of niobium, zirconium, hafnium, vanadium, tantalum, chromium, molybdenum, tungsten, their alloys, AlN and/or gas turbine protective layers. The protective layer is applied to the wall by plasma spraying.

### BACKGROUND OF THE INVENTION

1. Field of the Invention

The present invention concerns a vacuum housing for an x-ray tube having a wall provided with a protective layer at least in an area near a focal spot of the x-ray tube that arises in the operation of the x-ray tube, as well as a method for production of such a vacuum housing.

2. Description of the Prior Art

Particularly in the case of rotating anode x-ray tubes designed to save space, thermoshock stresses of the vacuum housing can occur in the vicinity of the focal spot. These stresses result from a secondary electron cloud that expands centrally from the focal spot with the beginning of the x-ray emission, The energy density of such a secondary electron cloud when incident on the inside of the vacuum enclosure can be so high that, between the cooled outside of the vacuum housing wall and the inside, a temperature difference occurs that leads to tensile stresses upon cooling and to thermoshock cracks or fissures given large stresses. Attempts to achieve relief by reduction of the wall thickness of the vacuum housing in the critical region, and thus to achieve a reduction of the thermoshock stress in the material does not lead to the desired results. Since a high local operating temperature and a high atmospheric pressure act on the cover of the evacuated housing, the material is no longer stable and begins to creep given a significant wall thickness reduction.

In German OS 199 14 825 and German OS 100 23 356, the inside of the vacuum housing is provided with a layer having a thermal absorption coefficient that is increased relative to the uncoated material of the vacuum housing, The optical properties of the inside of the vacuum housing should be changed to the affect that thermal radiation is absorbed better, and consequently the waste heat introduced in the anode upon the x-ray beam generation is dissipated faster. Unfortunately, such coatings do not offer protection against a thermoshock stress.

In order to increase the thermoshock resistance, and thus to increase the lifespan of the vacuum housing, it is proposed in German OS 196 12 220 to fashion the wall area that is adjacent the focal spot of the x-ray tube in operation of the x-ray tube from composite material formed of at least two layers. Its inner layer should exhibit a lower thermal expansion factor and/or a lower modulus of elasticity than the material of the outer layer. Feritic iron alloys or austenitic stainless steels are suited for the outer layer. Copper, nickel or at least alloys containing copper or nickel, in particular nickel-based alloys (known as compensation alloys with low thermal expansion factors) that contain iron, nickel and cobalt, as well as alloys comprising iron and nickel and also iron and palladium, are proposed as material for the inner layer. The wall of the vacuum housing can be the outer layer of the composite material that is provided with the inner layer serving as a protective layer.

With increasing extent of the stress level and the stress amount by the x-ray beam, however, the danger of thermal fatigue cracks (which is associated with a decreasing lifespan of the vacuum housing or of the x-ray tube) also increases with this type of coating.

### SUMMARY OF THE INVENTION

An object of the present invention is to provide a vacuum housing of the type initially described that exhibits a long lifespan in spite of increasing extent of the stress level and of the stress amount by the secondary electrons, as well as to provide a method to produce such a vacuum housing.

According to the invention, this object is achieved by a vacuum housing for an x-ray tube having a protective layer formed on a material selected from the groups consisting a niobium, zirconium, hafnium, vanadium, tantalum, chromium, molybdenum or tungsten, and their alloys, AlN, and gas turbine protective layers.

By applying a protective layer composed of such a material, a functional separation is achieved in a first inner material region that is “sacrificed” and fatigued and can form thermoshock cracks, and in a second, outer material region or the base material that is not so highly stressed and therefore is not deformed and furthermore remains vacuum-sealed. As a “deformation protective layer”, in comparison with the base material, this protective layer should consequently compensate the largest part of the thermoshock fatigue but be relatively thermoshock resistant in performing this function. The stressed materials ensure this function and thus increase the lifespan of the vacuum housing.

It has bee established that in particular the partial pressure of the coating material plays a significant role because the temperatures in the stress zone are high. The protective layer material should therefore preferably exhibits a smaller partial pressure than the base material (that is in, particular, an austenitic stainless steel) and thus exhibit a better temperature resistance.

In particular, it has been established that the protective layer materials should exhibit the following property combination for a high lifespan under the stresses that occur in a vacuum housing; lower thermal expansion factor, lower E-modulus (abbrev. For modulus of elasticity) and lower partial pressure than the wall or base material.

Due to the small thermal expansion factors, smaller mechanical thermal stresses ensue. Austenitic stainless steel has, for example, a high thermal expansion factor of 16·10-6/K. The thermal expansion factors of niobium, molybdenum, tantalum and tungsten are in the range of 4 to 6.5·10-6/K. Due to the smaller thermal expansion factor, the volume increase of the protective layer at the surface is smaller given temperature influence, and thus the danger of the separation of slip planes and the creation of cracks decreases.

The materials preferably also exhibit a ductile deformation property. Given fatigue cracks, particles are formed that could break away from the material surface, which would disadvantageously affect the stress resistance of the tube. These particles are structural constituents that are released given crack formation, and the stress concentration can increase by the release of such particles.

In particular niobium and/or its alloys are considered as preferred examples for this property combination. Niobium possesses the most advantageous combination of low partial pressure at increased operation temperature, small thermal expansion factors, small E-modulus and thus high ductility and low elastic limit. In contrast to the known materials nickel and cobalt, niobium exhibits a partial pressure and a low E-modulus which advantageously account for the temperature resistance and the ductility properties.

In addition to niobium, further transition metals from the 4th, 5th and 6th neighboring groups of the periodic table of the chemical elements and/or their alloys are considered as coating materials, in particular zirconium, hafnium, vanadium, tantalum, chromium, molybdenum or tungsten.

Tantalum and vanadium behave relatively similar to niobium and likewise belong to the preferred materials for a protective layer. However, relative to tantalum niobium exhibits the advantage that it is in comparison less significantly embrittled, which decreases the danger of particle formation when thermoshock cracks form. Relative to vanadium, niobium exhibits a lower partial pressure and thus a higher temperature resistance.

Molybdenum and tungsten exhibit lower partial pressure, a lower thermal expansion and an excellent heat conductivity, however, in comparison to niobium the danger of embrittling is greater. This is also true for tungsten-based alloys that, in comparison to pure tungsten exhibit a higher partial pressure and thus a better temperature resistance.

Furthermore, AlN is suitable for a protective layer. AlN has a good heat conductivity, which advantageously affects the protective layer properties and thus the lifespan of the vacuum housing.

Materials that are used for gas turbine protective layers are also suited for protective layers. They noticeably increase the lifespan of the vacuum housing. They are preferably comprised of a metallic layer made up of NiCrAlY or CoCrAlY with or without additives of rhenium, on which an oxidic coating is applied.

Gas turbine protective layers exhibit an advantageous lower partial pressure in comparison to austenitic stainless steel given temperatures up to 1,100° C., such that they are particularly suited as protective layer materials.

In addition to the particular material selection for the protective layer, the location of the coating also plays a role for the increase of the lifespan. It has been established that in particular the face of the opening of the shaft facing the anode space is stressed in a vacuum housing that has an anode chamber and a cathode chamber and a shaft connecting both these chambers, with the primary electron beam striking the anode through the shaft. For low material usage, in order to noticeably increase the lifespan preferably only the face of this opening is coated. It is sufficient to coat the face of the opening partially or in sections, and in particularly to coat only half, meaning in a semicircle on the side facing the radiation window.

For very high stresses, the face of the opening can also be completely coated, in the sense of all the way around.

The layer thickness or the protective layer preferably is 0.5 to 3 mm, with layer thicknesses of 0.5 to 0.7 mm giving quite good results.

As is known from German OS 196 12 220, the protective layer can be part of a two-layer composite material that is used in the wall of the vacuum housing, however the coating can be more economically applied on the base material with a coating method.

In the method according to the invention, the protective layer composed of the aforementioned material is applied on the wall by plasma spraying. In this method, a powder is melted in a plasma flame and accelerated and applied on the carrier material. For coating with niobium and/or its alloys, vacuum plasma spraying (VPS) is the most economical and also advantageous method in order to prevent niobium from entering into a brittle connection with another element. In particular, atmospheric plasma spraying (APS) is suitable for coating with gas turbine protective layers.

The desired protective layer thickness between 0.5 and 3 mm can be best applied by plasma spraying. In addition, the location of the coating can be arbitrarily limited with this method, which also makes possible the coating of only half the face of the opening. Moreover, this delimitation allows the diameter of the shaft with regard to the electron beam deflection to be not significantly reduced, which is an important criterion.

The soldering known from German OS 196 12 220 is also suitable as an application method, preferably soldering of a protective sleeve (“thermosleeve”). Plasma spraying is preferred, however, because soldering is expensive due to the necessary non-deformation for a material termination, and the risk of embrittling of the solder connection (solder joint) exists.

### DESCRIPTION OF THE DRAWINGS

FIG. 1 is a longitudinal section through a vacuum housing of an x-ray tube.

FIG. 2 is a plan view of a non-coated shaft opening face of the cover with thermoshock cracks.

FIG. 3 is a detailed view of FIG. 2, wherein half of the opening face is provided with a niobium protective layer.

FIG. 4 is a stress-number curve for an austenitic stainless steel.

FIG. 5 is a partial section through a vacuum housing of an x-ray tube according to the prior art.

### DESCRIPTION OF THE PREFERRED EMBODIMENTS

FIG. 5 shows a vacuum housing 1 (here a vacuum housing of a high-capacity x-ray tube for computed tomography) according to the prior art. A cathode arrangement 3 that includes a thermionic cathode 3c disposed in a focusing groove 3a of a cathode cover 3b is mounted in an insulator 2. Emanating from cathode 3c is an electron beam E (indicated dashed) that strikes a focal spot BF on the incident surface 4a of a rotating anode 4. The vacuum housing 1 is provided with a beam exit window (formed, for example, from beryllium) via which, in the operation of the x-ray tube, the x-ray beam E (the central and edge rays of which are indicated dashed and designated with ZS and RS) originating from the focal spot BF exits. Overall, the vacuum housing 1 is formed of a chamber 6 (anode chamber) containing the rotating anode 4 and a chamber 7 (cathode chamber) containing the cathode arrangement 3, that are connected with a shaft 8.

When, upon activation of the x-ray tube, the secondary electron stream begins to flow, and the vacuum housing 1 is subject to a thermoshock-like stress in its region adjacent to the focal spot BF. In order to increase the thermoshock resistance and to prevent thermoshock cracks, the wall 9 of the vacuum housing in the stressed region is provided with a protective layer 10.

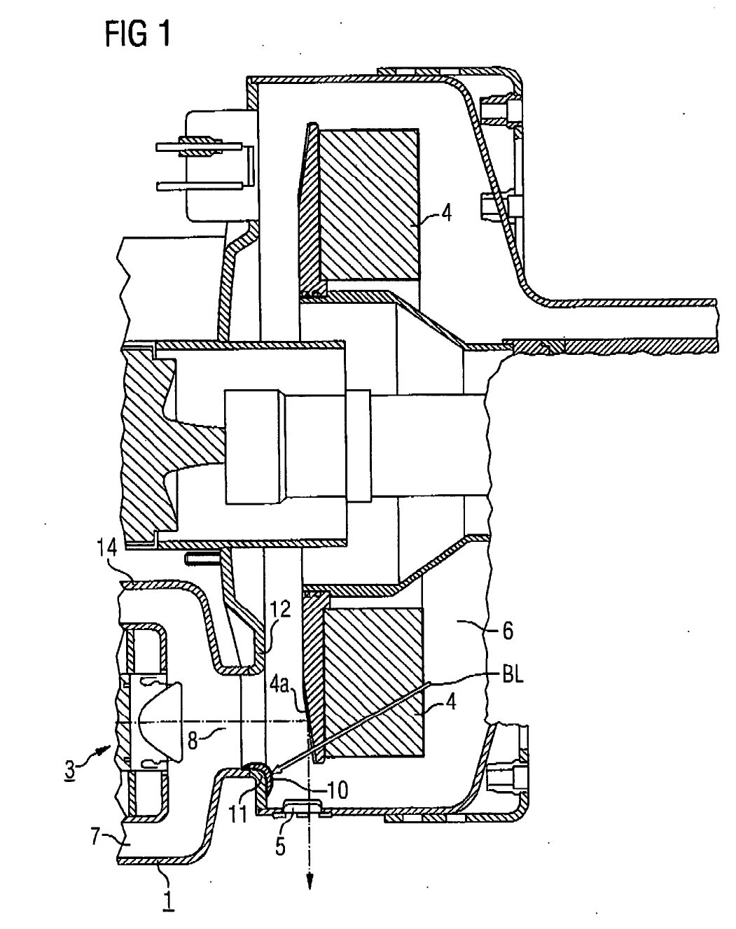

Using a somewhat modified embodiment of a vacuum housing 1 which, however, is comprised of the same components as the vacuum housing according to FIG. 5, FIG. 1 clarifies the region of the hole face 11 (endangered by the secondary electrons) of a shaft 8 arranged on a cover 12 of the vacuum housing 1, as well as the location of the coating. For identification, reference characters corresponding to the components of FIG. 5 are used.

The shaft 8 should separate the cathode chamber 7 from the anode chamber 8. In this manner, the cathode 3 is protected from the heat radiation of the entire anode plate and, due to the spatial separation, improves the stress resistance. Moreover, such a shaft 8 is an advantageous location to apply a deflection coil for the electron beam.

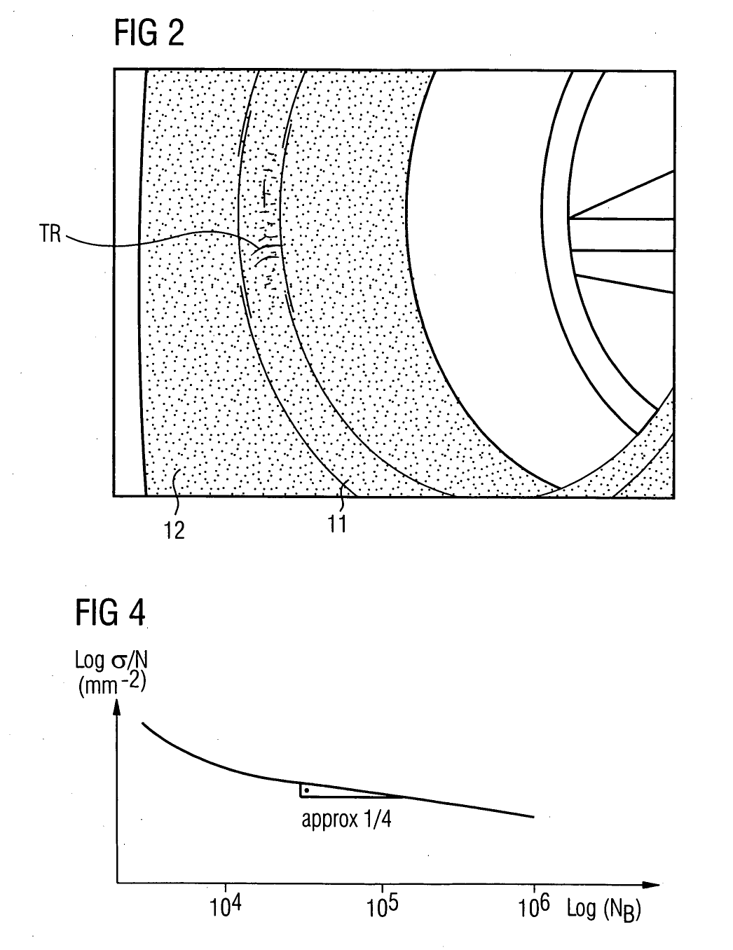

The opening of the shaft 8 in the cover 12 of the x-ray tube, i.e. the face 11 of the opening of the shaft 8, is particularly stressed upon operation of the x-ray tube. Upon each scan, a secondary electron cloud, the power density of which can be estimated to be at least 100 W/cm² is incident on this opening face 11. At the beginning of the scan, a thermoshock ensues that fatigues the material in the opening face 11. The consequences are thermoshock cracks TR in the opening face 11 in the junction to the cover 12, as the exposure in FIG. 2 clarifies. FIG. 2 is a microscopic exposure of the opening face 11 (in a viewing direction shown in FIG. 1 with an arrow BL) that shows the degree of the thermoshock cracks if the opening face 11 were not coated. The formation of the thermoshock cracks is dependent not on the duration of the stress, but rather only on the amplitude of the stress level and the number of stresses.

To reduce the thermoshock stress of the region of the wall of the vacuum housing 1 adjacent to the focal spot BR, the regions of the vacuum housing particularly at risk of material fatigue are provided with a protective layer 10. Particularly at risk is the facing region 11 of the shaft 8, and here in particular the opening facing half 13 that points in the direction of the beam output window 5.

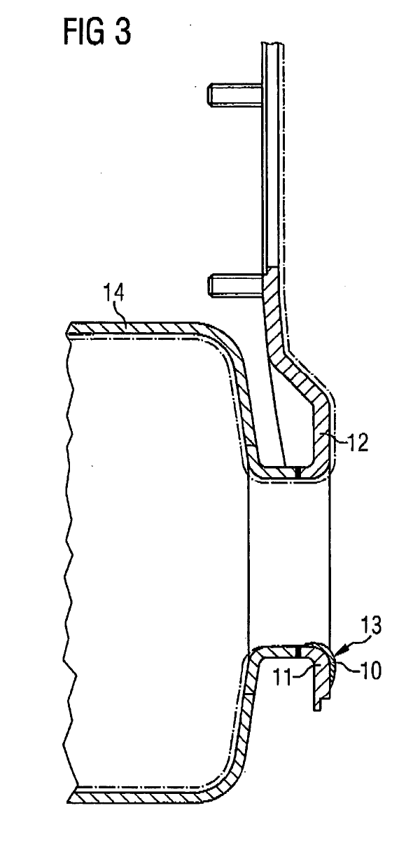

The detail view of FIG. 3 shows an x-ray tube with a vacuum housing 1 with potential 14 and cover 12. At the shaft 8, half of the opening face 11 has been coated with a thermal fatigue protective layer 10, namely on side 13 or the semicircle in the direction of the beam output window 5, which is particularly at risk.

The protective layer 10 that, in particular can be comprised of niobium, was applied with a vacuum plasma spray method and here exhibits a thickness of 0.5-0.7 mm. Niobium has proven to be particularly preferred for a protective layer. The reasons for this are that niobium is a very soft and ductile metal. Moreover, given very high temperature values it has a very small partial pressure or vapor pressure. The thermal expansion factor is very small, which makes the material more resistant to thermal fatigue than the wall material made of stainless steel. The ductility leads to only a very low probability that particles are released given structure fatigue.

The following explanations further explain the functioning of the protective layer.

The protective layer already compensates the largest part of the temperature difference. The mechanical stresses of the base material provided with a protective layer are thereby less high. This already leads to a substantial improvement of the present lifespan.

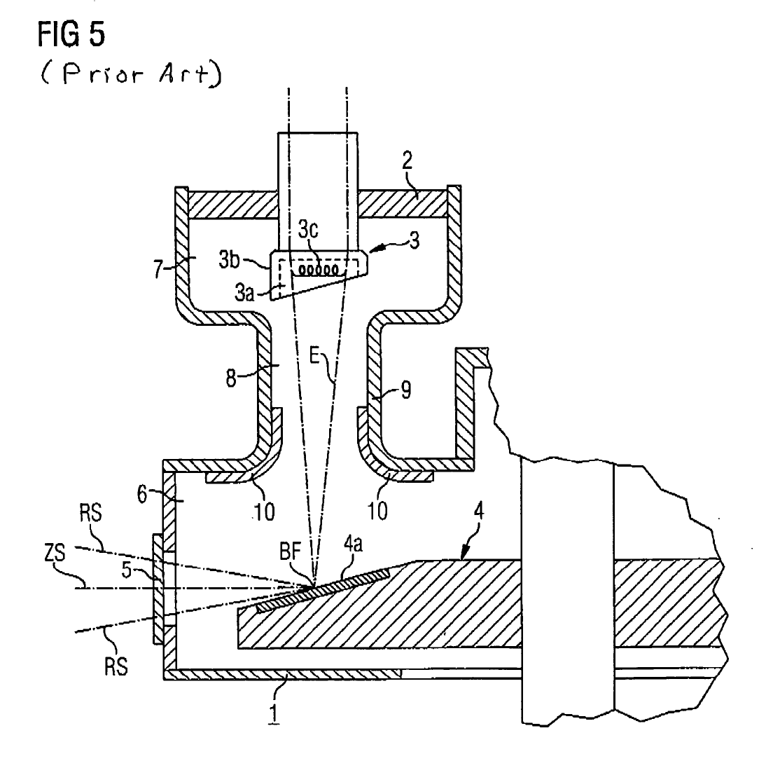

It should be considered that a lifespan expectancy of a factor of 4 can be achieved in steels given a reduction of the stress by approximately 30%. This connection between the stress change and the break or the breaking load number of operations given specific cyclical stresses is explained using the stress-number diagram for austenitic stainless steel according to FIG. 4.

The cycle number until the break depends on the −4th power of the mechanical stress. Given the reduction of the stress σ₁ by approximately 30% to a stress σ₂, a lifespan extension results of

$$log ( {σ}_{2} / {σ}_{1} ) / log ( {N}_{B2} / {N}_{B1} ) = - 1 / 4 ⇒ \\ log ( 1 / 0.7 ) / log ( {N}_{B2} / {N}_{B1} ) = - 1 / 4 ⇒ 0.6196 = \\ log ( {N}_{B2} / {N}_{B1} ) ⇒ {N}_{B1} \approx {N}_{B2} / 0.24 ⇒ {N}_{B1} \approx 4 {N}_{B2}$$

whereby N_{B1}, N_{B2} are the corresponding breaking load number of operations at the stresses σ₁, σ₂.

This means that the breaking load number of operations N_{B1} is increased by approximately a factor of 4 given a reduction of the stress by 30%. However, an increase of the breaking load number of operations by a factor of 2 is already a great achievement in a stress range of approximately 20,000 exposures.

Without the inventive coating with the stressed protective layer materials, thermoshock cracks result in the stressed areas. Examinations show the features of a stepped tear progression that exhibit an appearance similar to vibration bands given fatigue breaks. These vibration bands are created upon every scan or a plurality of scans. The start of the crack was in the face of the opening of the shaft of the cover, which is thus the most-stressed location, as is also shown in FIG. 2. Further examinations of the half of the hole face coated with niobium using surface parallel grindings showed the function of the protective layer. Only the protective layer exhibited cracks, while the base material without cracks exhibited a negligibly small crack.

The invention can also be employed in x-ray tubes known as single-pole (unipolar) x-ray tubes in which the vacuum housing and the anode are at a common potential. The invention also can be applied in tubes known as bipolar x-ray tubes in which the vacuum housing is at a potential that is between that of the anode and that of the cathode. Although the invention is described herein in the example of rotating anode x-ray tubes, fixed anode x-ray tubes also can be provided with an inventive vacuum housing.

Although modifications and changes may be suggested by those skilled in the art, it is the intention of the inventor to embody within the patent warranted hereon all changes and modifications as reasonably and properly come within the scope of his contribution to the art.

1. A vacuum housing for an x-ray tube, said x-ray tube having a focal spot form which x-rays and secondary electrons emanate, said vacuum housing comprising:
a housing wall;
a protective layer disposed at an interior of said housing wall at a location at which said secondary electrons are incident; and
said protective layer comprising at least one material selected from the group consisting of niobium, zirconium, hafnium, vanadium, tantalum, chromium, molybdenum, tungsten, alloys of niobium, alloys of zirconium, alloys of hafnium, alloys of vanadium, alloys of tantalum, alloys of chromium, alloys of molybdenum, alloys of tungsten, AlN, and gas turbine protective layer material.

2. A vacuum housing as claimed in claim 1 wherein said wall is comprised of wall material, and wherein said material comprising said protective layer as a lower partial pressure than said wall material.

3. A vacuum housing as claimed in claim 1 wherein said housing wall forms an anode chamber adapted to receive an anode therein, a cathode chamber adapted to receive a cathode therein, and a hollow shaft connecting an interior of said anode chamber with an interior of said cathode chamber, said shaft having an opening proceeding therethrough with a face of said opening disposed at said interior of said anode chamber, and wherein said protective layer at least partially covers said face of said opening.

4. A vacuum housing as claimed in claim 3 wherein said protective layer covers approximately one-half of said face of said opening.

5. A vacuum housing as claimed in claim 1 wherein said protective layer has a layer thickness in a range between 0.5 and 3 mm.

6. A vacuum housing as claimed in claim 1 wherein said housing wall is comprised of a metal.

7. A vacuum housing as claimed in claim 1 wherein said protective layer is applied to said housing wall as a coating.

8. A vacuum housing as claimed in claim 1 wherein said housing wall is comprised of two-layer composite material, and wherein said protective layer forms one layer of said two-layer composite material.

9. An x-ray tube comprising:
a cathode which emits an electron beam;
an anode on which electron beam is incident at a focal spot, from which x-rays and secondary electrons emanate;
a vacuum housing containing said cathode and said anode in an interior thereof; and
a protective layer disposed at said interior of said vacuum housing at a location at which said secondary electrons are incident, said protective layer being comprised of a material selected from the group consisting of niobium, zirconium, hafnium, vanadium, tantalum, chromium, molybdenum, tungsten, alloys of niobium, alloys of zirconium, alloys of hafnium, alloys of vanadium, alloys of tantalum, alloys of chromium, alloys of molybdenum, alloys of tungsten, AlN, and gas turbine protective layer material.

10. An x-ray tube as claimed in claim 9 wherein said vacuum housing is comprised of housing material, and wherein said material comprising said protective layer has a lower partial pressure than said housing material.

11. An x-ray tube as claimed in claim 9 wherein said vacuum housing comprises an anode chamber in which said anode is disposed, a cathode chamber in which said cathode is disposed, and a hollow shaft connecting said anode chamber with said cathode chamber, said hollow shaft having an opening through which said electron beam proceeds, with a face of said opening disposed in said anode chamber at said location at which said secondary electrons are incident, and wherein said protective layer at least partially covers said face of said opening.

12. An x-ray tube as claimed in claim 11 wherein said protective layer covers approximately one-half of said face of said opening.

13. An x-ray tube as claimed in claim 9 wherein said protective layer has a layer thickness in a range between 0.5 and 3 mm.

14. An x-ray tube as claimed in claim 9 wherein said vacuum housing is comprised of metal.

15. An x-ray tube as claimed in claim 9 wherein said protective layer is a coating at said location at said interior of said vacuum housing.

16. An x-ray tube as claimed in claim 1 wherein said vacuum housing is comprised of a two-layer composite material, and wherein said protective layer forms one layer of said two-layer composite material.

17. A method for manufacturing a vacuum housing for an x-ray tube, said x-ray tube, in operation, having a focal spot from which x-rays and secondary electrons emanate and having a vacuum housing with an interior having a location at which said secondary electrons are incident, said method comprising the steps of:
applying a protective layer by plasma spraying at said location at said interior of said vacuum housing; and
selecting a material for said protective layer from the group consisting of niobium, zirconium, hafnium, vanadium, tantalum, chromium, molybdenum, tungsten, alloys of niobium, alloys of zirconium, alloys of hafnium, alloys of vanadium, alloys of tantalum, alloys of chromium, alloys of molybdenum, alloys of tungsten, AlN, and gas turbine protective layer material.

18. A method as claimed in claim 17 wherein the step of applying said protective layer comprises applying said protective layer by plasma spraying selected from the group consisting of vacuum plasma spraying and atmospheric plasma spraying.

19. A method as claimed in claim 17 wherein said vacuum housing has a cathode chamber and an anode chamber connected by a hollow shaft, said shaft having an opening therein which opens at an opening face into said anode chamber, and wherein the step of applying said protective layer comprises applying said protective layer at said opening face.
